(19) United States
(12) Patent Application Publication
(10) Pub. No.: US 2017/0292713 A1
(43) Pub. Date: Oct. 12, 2017

(54) System and Method for Controlling Oven Humidity

(71) Applicant: General Electric Company, Schenectady, NY (US)

(72) Inventors: Stephen Christopher Boedicker, Louisville, KY (US); Jianwu Li, Louisville, KY (US)

(21) Appl. No.: 15/092,640

(22) Filed: Apr. 7, 2016

(51) Int. Cl. F24C 15/00

(52) U.S. Cl. CPC F24C 15/006; A23L 5/10; A23V 2002/00

(57) ABSTRACT

A system and method for controlling the humidity in a cooking chamber of an oven appliance is provided. The oven appliance includes a cooking chamber, a cooling air flow passageway positioned outside the cooking chamber, a cooling fan positioned in the cooling air flow passageway, and a vent enabling flow communication between the cooking chamber and cooling air flow passageway. One or more humidity sensors may be placed in or around the oven appliance to measure the humidity of the ambient air and the humidity of the air in the cooking chamber. A controller may achieve improved humidity control of the cooking chamber by selectively operating the cooling fan to adjust the humidity within the cooking chamber based on the measured humidity of the ambient air and the air in the cooking chamber.

### FIELD OF THE INVENTION

The present disclosure relates generally to an oven appliance, or more specifically, to a method for controlling humidity inside a cooking chamber of an oven appliance.

### BACKGROUND OF THE INVENTION

Oven appliances generally include a cabinet that defines a cooking chamber for receipt of food items for cooking. Heating elements are positioned within the cooking chamber to provide heat to food items located therein. The heating elements can include a bake heating element positioned at a bottom of the cooking chamber and/or a broil heating element positioned at a top of the cooking chamber. Oven appliances may also include a convection heating assembly, which may include a convection heating element and fan or other mechanism for creating a flow of heated air within the cooking chamber.

During operation of oven appliances, the humidity within the cooking chamber may vary due to a variety of factors. For example, moisture given off by food being cooked may increase the humidity within the chamber. In addition, ambient air, which may have a low or high relative humidity depending on the environment in which the oven is located, may be drawn into the cooking chamber during the cooking operation, thereby affecting chamber humidity. Moreover, the amount of ambient air drawn into the cooking chamber may vary, for example, depending on the type of door gasket used, the presence and size of any vent openings, and the speed of a cooling fan.

Improved cooking performance could be achieved if the humidity level within the cooking chamber was controlled. However, because of the high temperatures (e.g., up to 500° F. during cooking, and over 800° F. during self-cleaning) that can be encountered in the cooking chamber, the use of humidity sensors may not be possible or practical. For example, such sensors may not be able to withstand such higher temperatures, direct exposure to IR radiation from the heating elements, or direct exposure to splattered substances, e.g., grease or oil. Alternatively, the cost of providing more temperature resistant sensors may be prohibitive.

Accordingly, an oven appliance that provides improved cooking performance by allowing for humidity control inside a cooking chamber would be useful. More particularly, a method of controlling the humidity of the cooking chamber based on the humidity of the ambient air and the air in the cooking chamber would be especially beneficial.

### BRIEF DESCRIPTION OF THE INVENTION

The present subject matter provides a system and method for controlling the humidity in a cooking chamber of an oven appliance. The oven appliance includes a cooking chamber, a cooling air flow passageway positioned outside the cooking chamber, a cooling fan positioned in the cooling air flow passageway, and a vent enabling flow communication between the cooking chamber and cooling air flow passageway. One or more humidity sensors may be placed in or around the oven appliance to measure the humidity of the ambient air and the humidity of the air in the cooking chamber. A controller may achieve improved humidity control of the cooking chamber by selectively operating the cooling fan to adjust the humidity within the cooking chamber based on the measured humidity of the ambient air and the air in the cooking chamber. Additional aspects and advantages of the invention will be set forth in part in the following description, may be apparent from the description, or may be learned through practice of the invention.

In one exemplary embodiment, an oven appliance defining a vertical direction, a lateral direction, and a transverse direction is provided. The oven appliance includes a cabinet defining a cooking chamber and an opening for receiving food items for cooking. The oven appliance also includes a door being rotatably hinged to the cabinet to provide selective access to the cooking chamber and a cooling air flow passageway positioned outside of the cooking chamber. A vent is defined by the cabinet and enables flow communication between the cooking chamber and the cooling air flow passageway. A cooling fan is in communication with the cooling air flow passageway and is configured for urging air flow through the cooling air flow passageway. A cooking chamber humidity sensor is positioned within the cooling air flow passageway and a controller is configured to control the humidity in the cooking chamber by selectively operating the cooling fan in response to a measured humidity from the cooking chamber humidity sensor.

In another exemplary embodiment, a method for controlling the humidity within a cooking chamber of an oven appliance is provided. The oven appliance includes a cabinet defining the cooking chamber, a cooling air flow passageway positioned outside the cooking chamber, a cooling fan in flow communication with the cooling air flow passageway, and a humidity sensor. The method includes measuring a humidity using the humidity sensor and selectively operating the cooling fan in response to the measured humidity to adjust the humidity in the cooking chamber.

In still another exemplary embodiment, an oven appliance defining a vertical direction, a lateral direction, and a transverse direction is provided. The oven appliance includes a cooking chamber configured for the receipt of food items for cooking, the cooking chamber defined by a top wall, a bottom wall, and a vertically-oriented back wall. A door provides selective access to the cooking chamber and a cooling air flow passageway is positioned outside of the cooking chamber. A vent is defined by the top wall and enables flow communication between the cooking chamber and the cooling air flow passageway. A cooling fan is positioned within the cooling air flow passageway and is configured for urging air flow through the cooling air flow passageway. An ambient air humidity sensor is configured to measure the humidity of ambient air and a controller is configured to control the humidity in the cooking chamber by selectively operating the cooling fan in response to a measured humidity from the ambient air humidity sensor.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an oven appliance according to an exemplary embodiment of the present subject matter.

FIG. 2 provides a cross-sectional view of the oven appliance of FIG. 1.

FIG. 3 illustrates a method for operating an oven appliance according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

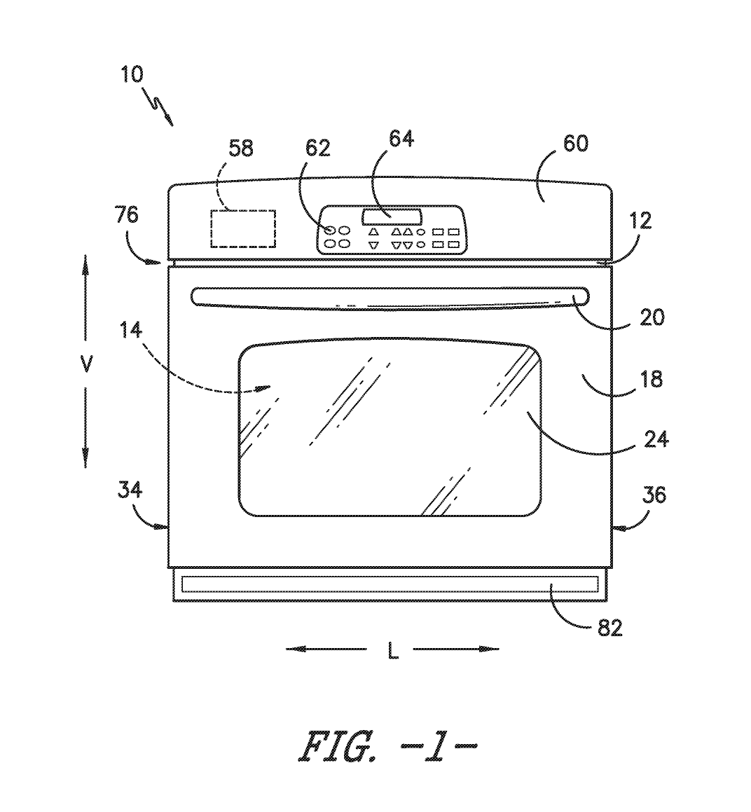

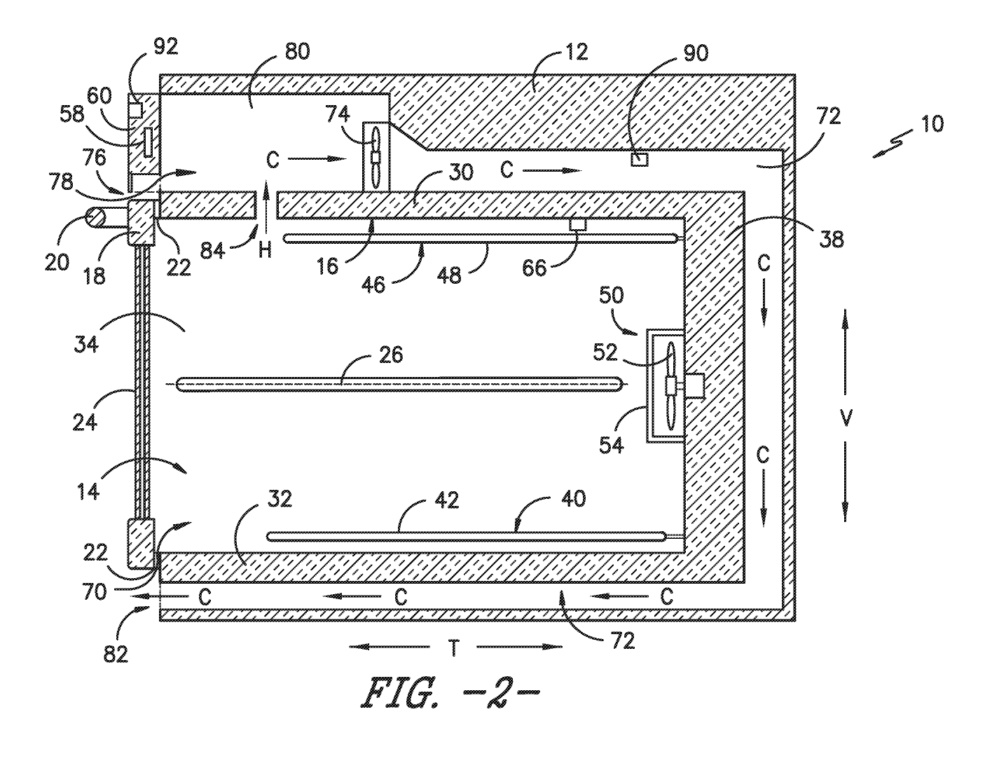

FIGS. 1 and 2 depict an exemplary oven appliance 10 that may be configured in accordance with aspects of the present disclosure. FIG. 1 provides a front view of oven appliance 10 according to an exemplary embodiment of the present subject matter. FIG. 2 provides a cross sectional view of the exemplary oven appliance 10 of FIG. 1. For the particular embodiment of FIGS. 1 and 2, oven appliance 10 defines a vertical direction V, a lateral direction L, and a transverse direction T. The vertical, lateral and transverse directions are mutually perpendicular and form an orthogonal direction system. As will be understood by those skilled in the art, oven appliance 10 is provided by way of example only, and the present subject matter may be used in any suitable cooking appliance. Thus, the present subject matter may be used with other oven appliances having different configurations, such as range ovens, electric ovens, gas ovens, microwave ovens, etc.

Oven appliance 10 includes an insulated cabinet 12 with an interior cooking chamber 14 defined by an interior surface 16 of cabinet 12. Cooking chamber 14 is configured for the receipt of one or more food items to be cooked. Oven appliance 10 includes a door 18 rotatably mounted to cabinet 12, e.g., with a hinge (not shown). A handle 20 is mounted to door 18 and assists a user with opening and closing door 18 in order to access cooking chamber 14. For example, a user can pull on handle 20 to open or close door 18 and access cooking chamber 14.

Oven appliance 10 can include a seal, e.g., gasket 22, between door 18 and cabinet 12 that assists with maintaining heat and cooking fumes within cooking chamber 14 when door 18 is closed as shown in FIG. 2. Door 18 may include a window 24, constructed for example from multiple parallel glass panes, to provide for viewing the contents of cooking chamber 14 when door 18 is closed and assist with insulating cooking chamber 14. A baking rack 26 is positioned in cooking chamber 14 for the receipt of food items or utensils containing food items. Baking rack 26 may be slidably received onto embossed ribs or sliding rails (not shown) such that rack 26 may be conveniently moved into and out of cooking chamber 14 when door 18 is open.

As shown, various sidewalls define the cooking chamber 14. For example, cooking chamber 14 includes a top wall 30 and a bottom wall 32 which are spaced apart along the vertical direction V. Left sidewall 34 and right sidewall 36 (as defined according to the view as shown in FIG. 1) extend between the top wall 30 and bottom wall 32, and are spaced apart along the lateral direction L. A rear wall 38 may additionally extend between the top wall 30 and bottom wall 32 as well as between the left sidewall 34 and right sidewall 36, and is spaced apart from the door 18 along the transverse direction T. Cooking chamber 14 is thus defined between the top wall 30, bottom wall 32, left sidewall 34, right sidewall 36, and rear wall 38.

A lower heating assembly, e.g., bake heating assembly 40, may be included in oven appliance 10, and may include one or more heating elements, e.g. bake heating elements 42. Bake heating elements 42 may be disposed within the cooking chamber 14, such as adjacent bottom wall 32. In exemplary embodiments as illustrated, the bake heating elements 42 are electric heating elements, as is generally understood. Alternatively, the bake heating elements 42 may be gas burners or other suitable heating elements having other suitable heating sources. Bake heating elements 42 may generally be used to heat cooking chamber 14 for both cooking and cleaning of oven appliance 10.

Additionally, an upper heating assembly, e.g., broil heating assembly 46, may be included in oven appliance 10, and may include one or more upper heating elements, e.g., broil heating elements 48. Broil heating elements 48 may be disposed within the cooking chamber 14, such as adjacent top wall 30. In exemplary embodiments as illustrated, the broil heating elements 48 are electric heating elements, as is generally understood. Alternatively, the broil heating elements 48 may be gas burners or other suitable heating elements having other suitable heating sources. Broil heating elements 48 may additionally generally be used to heat cooking chamber 14 for both cooking and cleaning of oven appliance 10.

Oven appliance 10 may also include a convection heating assembly 50. Convection heating assembly 50 may have a fan 52 and a convection heating element 54. Convection heating assembly 50 is configured for selectively urging a flow of heated air into cooking chamber 14. For example, fan 52 can pull air from cooking chamber 14 into convection heating assembly 50 and convection heating element 54 can heat such air. Subsequently, fan 52 can urge such heated air back into cooking chamber 14. As another example, fan 52 can cycle heated air from cooking chamber 14 within cooking chamber 14 in order to generate forced convective air currents without use of convection heating element 54. Like heating elements 42, 48 discussed above, convection heating element 54 may be, e.g., a gas, electric, or microwave heating element or any suitable combination thereof. According to an alternative exemplary embodiment, convection heating assembly 50 need not include fan 52.

Oven appliance 10 is further equipped with a controller 58 to regulate operation of the oven appliance 10. For example, controller 58 may regulate the operation of oven appliance 10 including heating elements 42, 48, 54 (and heating assemblies 40, 46, 50 generally). Controller 58 may be in communication (via for example a suitable wired or wireless connection) with the heating elements 42, 48, 54 and other suitable components of the oven appliance 10, as discussed herein. In general, controller 58 may be operable to configure the oven appliance 10 (and various components thereof) for cooking. Such configuration may be based on a plurality of cooking factors, selected operating cycles, sensor feedback, etc., as discussed herein.

By way of example, controller 58 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 58 may be positioned in a variety of locations throughout oven appliance 10. In the illustrated embodiment, controller 58 may be located within a user interface panel 60 of oven appliance 10 as shown in FIGS. 1 and 2. In such an embodiment, input/output (“I/O”) signals may be routed between the control system and various operational components of oven appliance 10 along wiring harnesses that may be routed through cabinet 12. Typically, controller 58 is in communication with user interface panel 60 and controls 62 through which a user may select various operational features and modes and monitor progress of oven appliance 10. In one embodiment, user interface 60 may represent a general purpose I/O (“GPIO”) device or functional block. In one embodiment, user interface 60 may include input components or controls 62, such as one or more of a variety of electrical, mechanical or electro-mechanical input devices including rotary dials, push buttons, and touch pads. User interface 60 may include a display component, such as a digital or analog display device 64 designed to provide operational feedback to a user.

User interface 60 may be in communication with controller 58 via one or more signal lines or shared communication busses. Controller 58 may also be communication with one or more sensors, e.g., a temperature sensor 66 that is used to measure temperature inside cooking chamber 14 and provide such measurements to controller 58. Temperature sensor 66 may be a thermocouple, a thermistor, a resistance temperature detector, or any other device suitable for measuring the temperature within cooking chamber 14. Temperature sensor 66 is shown (in FIG. 2) in the top and rear of cooking chamber 14. However, other locations may be used and, if desired, multiple temperature sensors may be applied as well. In this manner, controller 58 may selectively control heating elements 42, 48, 54 and provide a temperature indication to the user with display 64 in response to temperature feedback from temperature sensor 66. Controller 58 can also be provided with other features as will be further described herein.

During operation of oven appliance 10 in both cooking and cleaning cycles, the temperatures that are needed in cooking chamber 14 can be high. Insulation in top wall 30, bottom wall 32, sidewalls 34, 36, and rear wall 38 helps reduce heat transfer from cooking chamber 14 to e.g., surrounding cabinetry or ambient air. Door 18 is provided with insulation as well. Gasket 22 provides thermal insulation but also allows a certain amount of ambient air to be drawn into cooking chamber 14 during certain cooking operations as indicated by arrow 70. In this regard, gasket 22 may be porous or may have a plurality of small holes that permit ambient air to flow through gasket 22 into cooking chamber 14.

Oven appliance 10 is provided with a cooling system whereby ambient air is used to help cool oven appliance 10. More specifically, a cooling air flow passageway 72 is formed adjacent walls 30-38 of oven appliance 10. Passageway 72 is shown schematically in FIG. 2. As illustrated, cooling air flow passageway 72 wraps around cooking chamber 14 to provide convective cooling to walls 30-38 and prevent overheating of cabinet 12. More specifically, cooling air flow passageway 72 extends from a front surface of oven appliance 10, across top wall 30, down rear wall 38, and along bottom wall 32 back to the front of cabinet 12. As will be understood by one of skill in the art using the teachings disclosed herein, cooling air flow passageway 72 may have a variety of configurations other than as shown.

In operation, a cooling fan 74 moves air through passageway 72 by drawing ambient air through an entrance 76 (arrow 78) positioned between door 18 and user interface panel 60. Cooling fan 74 also pulls this cooler, ambient air through the electronics bay 80, which is connected with cooling air flow passageway 72. The flow of air through passageway 72 is indicated by arrows C in FIG. 2. After flowing past walls 30-38 to provide convective cooling, the air exits passageway 72 through cooling air flow exit 82. Cooling fan 74 may be any fan or device suitable for urging air flow through cooling air flow passageway 72. For example, cooling fan 74 may be an axial fan positioned within cooling air flow passageway 72. According to the illustrated embodiment, cooling fan 74 is positioned adjacent top wall 30 proximate to electronics bay 80. However, alternative types of cooling fans, locations, and configurations are also possible and within the scope of the present subject matter.

Cooling fan 74 also pulls air from cooking chamber 14 through a vent 84. In general, vent 84 may be any aperture defined by the cabinet 12 that enables flow communication between cooking chamber 14 and the cooling air flow passageway 72. For example, vent 84 is typically a round, small diameter port located in top wall 30 of cooking chamber 14. The air withdrawn from cooking chamber 14 is replaced by ambient air drawn into cooking chamber 14 through the gasket 22 between door 18 and walls 30-36 as indicated by arrow 70. Notably, such ventilation of cooking chamber 14 may remove e.g., moisture and gases released during cooking operations, as discussed below.

Although vent 84 is illustrated as a single aperture defined in top wall 30 of cooking chamber 14, one skilled in the art will appreciate that other configurations and locations of vent 84 are possible. For example, vent 84 could also be configured as a chute, a conduit, or as a series of apertures. In addition, vent 84 could alternatively be positioned in any one of walls 30-38, or may include multiple apertures positioned in such walls in any suitable combination. A variety of configurations may be used provided a flow communication between cooking chamber 14 and cooling air flow passageway 72 is achieved.

According to the illustrated embodiment of FIG. 2, oven appliance 10 also includes two humidity sensors. More specifically, a cooking chamber humidity sensor 90 is positioned within cooling air flow passageway 72 and is configured to measure the humidity of air in cooking chamber 14. Notably, because cooking chamber humidity sensor 90 is positioned within cooling air flow passageway 72, it is not subjected to the extreme temperatures of cooking chamber 14. However, cooking chamber humidity sensor 90 is still capable of providing an accurate measurement of the humidity of air drawn from cooking chamber 14 through vent 84.

In addition, an ambient air humidity sensor 92 is positioned within user interface panel 60 and is configured to measure the humidity of ambient air, i.e., air from the environment surrounding oven appliance 10. Notably, by knowing the humidity of the ambient air flowing through entrance 76 (i.e., as shown by arrow 78) and through gasket 22 (i.e., as shown by arrow 70), the measurement of humidity provided by cooking chamber humidity sensor 90 can be used to precisely determine the humidity inside cooking chamber 14.

According to the illustrated exemplary embodiment of FIG. 2, cooking chamber humidity sensor 90 is placed downstream of cooling fan 74 in cooling air flow passageway 72. Positioning the cooking chamber humidity sensor 90 downstream of cooling fan 74 provides a cooler operating environment for the sensor while still allowing for accurate determination of the humidity of air drawn through vent 84 from cooking chamber 14. In addition, ambient air humidity sensor 92 is positioned in user interface panel 60 of oven appliance 10. For example, ambient air humidity sensor 92 may extend from a front face of user interface panel 60 in order to accurately measure the humidity of the environment in which oven appliance 10 is operating.

Although two humidity sensors 90, 92 are illustrated, one skilled in the art will appreciate that one or more humidity sensors may be used in accordance with exemplary embodiments of the present subject matter. The illustration of two humidity sensors 90, 92 is not intended to be limiting, but is used only for the purposes of explanation. In addition, the locations of the humidity sensors 90, 92 are only exemplary. One skilled in the art will appreciate that the humidity sensors 90, 92 may be placed at other locations in and around oven appliance 10 while remaining within the scope of the present subject matter.

Although temperature sensor 66 and humidity sensors 90, 92 are used for the exemplary embodiments shown in the figures, other types of sensors could be used instead or in addition thereto. These sensors can be of a variety of types, designed to measure a quantity or characteristic of the air, such as e.g. humidity, density, chemical composition, pH, a chemical compound sensor (e.g. VOCs, alcohols, keytones, oxygen, propane, methane, etc.), aroma/scent, smoke, dust, grease/oil droplets, and others as well.

It should be appreciated that the invention is not limited to any particular style, model, or configuration of oven appliance 10. The exemplary embodiment depicted in FIGS. 1 and 2 is for illustrative purposes only. For example, different locations may be provided for user interface 60, different configurations of cooling air flow passageway 72, cooling fan 74, and sensors 90, 92 may be used, and other differences may be applied as well. In addition, the oven appliance 10 may be a range oven, an oven/range combo, a microwave oven, an electric oven, a gas oven, etc.

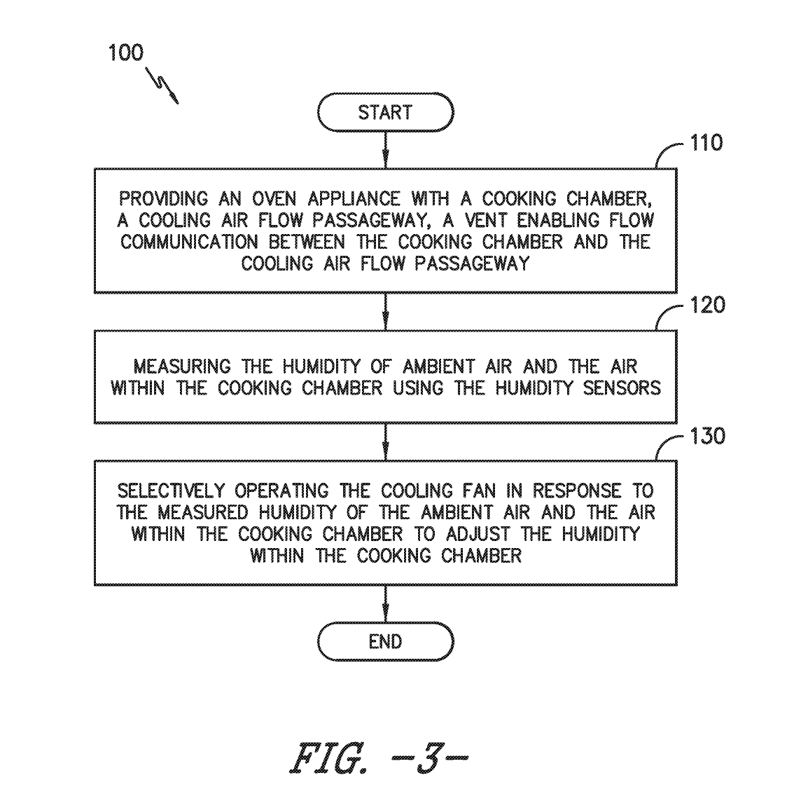

Now that the construction and configuration of oven appliance 10 according to an exemplary embodiment of the present subject matter have been presented, an exemplary method 100 of controlling the humidity within cooking chamber 14 of oven appliance 10 will be described. FIG. 3 illustrates method 100 for operating an appliance, such as oven appliance 10, according to exemplary embodiments of the present subject matter. It should be understood that method 100 may be used in other oven appliances as well, such as range oven appliances.

Method 100 is a method for controlling the humidity within an oven appliance, e.g., within cooking chamber 14 of oven appliance 10. In particular, method 100 facilitates improving the overall cooking performance of oven appliance 10 by controlling not only the temperature of the cooking chamber 14, but the humidity within cooking chamber 14 throughout a cooking cycle. In this regard, the discussion below refers to performing method 100 using cooling fan 74 and humidity sensors 90, 92. However, one skilled in the art will appreciate that aspects of method 100 may be used to control humidity within oven appliances having different configurations, such as different cooling air flow passageways, a different number or location of cooling fans, and a different number or type of sensors. Controller 58 may be programmed to perform method 100, e.g., by selectively operating cooling fan 74 in response to a measured humidity from at least one of cooking chamber humidity sensor 90 and ambient air humidity sensor 92.

Method 100 may include, at step 110 providing and oven appliance, such as oven appliance 10, for the purpose of cooking food items. More specifically, for the purpose of explaining method 100, oven appliance 10 will have cooking chamber 14, cooling air flow passageway 72, vent 84 enabling flow communication between cooking chamber 14 and cooling air flow passageway 72, cooling fan 74, and humidity sensors 90, 92.

Step 120 includes measuring the humidity of ambient air and the air within cooking chamber 14 using humidity sensors 90, 92. Finally, step 130 includes selectively operating cooling fan 74 in response to the measured humidity of the ambient air and the air within cooking chamber 14 to adjust the humidity within cooking chamber 14.

For example, if oven appliance 10 is being used to cook food products that cook better in a humid environment, controller 58 may sense the humidity of both the air in cooking chamber 14, e.g., using cooking chamber humidity sensor 90 and the ambient air, e.g., using ambient air humidity sensor 92. If ambient air is more humid than the air within cooking chamber 14, cooling fan 74 may operate to draw humid, ambient air from the outside environment through gasket 22 into cooking chamber 14 while drawing the dryer air out of cooking chamber 14. By contrast, if ambient air is dryer than the air within cooking chamber 14, cooling fan 74 may remain off to avoid drawing in the dry ambient air from the outside environment through gasket 22 into cooking chamber 14. In this manner, the food may continue to cook in a humid environment.

Alternatively, if oven appliance 10 is being used to cook food products that cook better in a dry environment, controller 58 may sense the humidity of both the air in cooking chamber 14, e.g., using cooking chamber humidity sensor 90 and the ambient air, e.g., using ambient air humidity sensor 92. If ambient air is dryer than the air within cooking chamber 14, cooling fan 74 may operate to draw dry, ambient air from the outside environment through gasket 22 into cooking chamber 14 while drawing the humid air out of cooking chamber 14. By contrast, if ambient air is more humid than the air within cooking chamber 14, cooling fan 74 may remain off to avoid drawing in the humid ambient air from the outside environment through gasket 22 into cooking chamber 14.

One skilled in the art will appreciate that method 100 of operating cooling fan 74 described above is only one exemplary way of controlling the humidity within cooking chamber 14. Other methods of operating cooling fan 74 in response to cooking chamber humidity sensor 90 and ambient air humidity sensor 92 are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An oven appliance defining a vertical direction, a lateral direction, and a transverse direction, the oven appliance comprising:
a cabinet defining a cooking chamber and an opening for receiving food items for cooking;
a door being rotatably hinged to the cabinet to provide selective access to the cooking chamber;
a cooling air flow passageway positioned outside of the cooking chamber;
a vent defined by the cabinet and enabling flow communication between the cooking chamber and the cooling air flow passageway;
a cooling fan in communication with the cooling air flow passageway and configured for urging air flow through the cooling air flow passageway;
a cooking chamber humidity sensor positioned within the cooling air flow passageway; and
a controller configured to control the humidity in the cooking chamber by selectively operating the cooling fan in response to a measured humidity from the cooking chamber humidity sensor.

2. The oven appliance of claim 1, wherein the air flow urged by the cooling fan comprises ambient air and air drawn from the cooking chamber through the vent.

3. The oven appliance of claim 1, further comprising a gasket positioned between the door and the cabinet when the door is in a closed position, wherein the cooling fan may draw ambient air into the cooking chamber through the gasket.

4. The oven appliance of claim 3, wherein the gasket is attached to the door and comprises small apertures through which ambient air is drawn into the cooking chamber by the cooling fan.

5. The oven appliance of claim 1, wherein the vent is defined in a top wall of the cabinet and opens into the cooling air flow passageway upstream of the cooling fan.

6. The oven appliance of claim 1, wherein the humidity sensor is placed downstream of the cooling fan in the cooling air flow passageway.

7. The oven appliance of claim 1, further comprising an ambient air humidity sensor for measuring the humidity of ambient air.

8. The oven appliance of claim 7, wherein the ambient air humidity sensor is positioned in a control panel of the oven appliance.

9. A method for controlling the humidity within a cooking chamber of an oven appliance, the oven appliance comprising a cabinet defining the cooking chamber, a cooling air flow passageway positioned outside the cooking chamber, a cooling fan in flow communication with the cooling air flow passageway, and a humidity sensor, the method comprising:
measuring a humidity using the humidity sensor; and
selectively operating the cooling fan in response to the measured humidity to adjust the humidity in the cooking chamber.

10. The method of claim 9, wherein the humidity sensor is a cooking chamber humidity sensor positioned within the cooling air flow passageway.

11. The method of claim 10, wherein the oven appliance further comprises an ambient air humidity sensor positioned within a control panel of the oven appliance and configured to measure the humidity of ambient air, the method further comprising:
selectively operating the cooling fan in response to the measured humidity of air by both the cooking chamber humidity sensor and the ambient air humidity sensor.

12. The method of claim 9, wherein the humidity sensor is an ambient air humidity sensor positioned within a control panel of the oven appliance and configured to measure the humidity of ambient air.

13. The method of claim 12, wherein the oven appliance further comprises a cooking chamber humidity sensor positioned within the cooling air flow passageway, the method further comprising:
selectively operating the cooling fan in response to the measured humidity of air by both the cooking chamber humidity sensor and the ambient air humidity sensor.

14. An oven appliance defining a vertical direction, a lateral direction, and a transverse direction, the oven appliance comprising:
a cooking chamber configured for the receipt of food items for cooking, the cooking chamber defined by a top wall, a bottom wall, and a vertically-oriented back wall;
a door for providing selective access to the cooking chamber;
a cooling air flow passageway positioned outside of the cooking chamber;
a vent defined by the top wall and enabling flow communication between the cooking chamber and the cooling air flow passageway;
a cooling fan positioned within the cooling air flow passageway and configured for urging air flow through the cooling air flow passageway;
an ambient air humidity sensor configured to measure the humidity of ambient air; and
a controller configured to control the humidity in the cooking chamber by selectively operating the cooling fan in response to a measured humidity from the ambient air humidity sensor.

15. The oven appliance of claim 14, wherein the air flow urged by the cooling fan comprises ambient air and air drawn from the cooking chamber through the vent.

16. The oven appliance of claim 14, further comprising a gasket attached to the door such that it forms a seal between the door and the cooking chamber when the door is in a closed position, wherein the cooling fan may draw ambient air into the cooking chamber through the gasket.

17. The oven appliance of claim 14, wherein the vent opens into the cooling air flow passageway upstream of the cooling fan.

18. The oven appliance of claim 14, wherein the ambient air humidity sensor is positioned in a control panel of the oven appliance.

19. The oven appliance of claim 14, further comprising a cooking chamber humidity sensor.

20. The oven appliance of claim 19, wherein the cooking chamber humidity sensor is placed downstream of the cooling fan in the cooling air flow passageway.
